(19) United States
(12) Patent Application Publication
(10) Pub. No.: US 2022/0114500 A1
(43) Pub. Date: Apr. 14, 2022

(54) MECHANISM FOR POISON DETECTION IN A FEDERATED LEARNING SYSTEM

(71) Applicant: Intel Corporation, Santa Clara, CA (US)

(72) Inventors: Alex Nayshtut, Gan Yavne D (IL); Raizy Kellermann, Jerusalem (IL); Omer Ben-Shalom, Rishon Le-Tzion (IL)

(73) Assignee: Intel Corporation, Santa Clara, CA (US)

(21) Appl. No.: 17/558,744

(22) Filed: Dec. 22, 2021

(51) Int. Cl. G06N 20/20; G06F 21/64

(52) U.S. Cl. CPC G06N 20/20; G06F 21/64

(57) ABSTRACT

An apparatus is disclosed. The apparatus comprises one or more processors to receive trained model update data from each of a plurality of collaborators, execute an auxiliary machine learning model to the trained model update data to generate a risk score for trained model update data associated with each collaborator, apply one or more policies based on the risk scores to generate adjusted trained model update data associated with each collaborator.

### BACKGROUND

Machine Learning (ML) models are trained using sensitive real-world data in order to provide improvements to a wide variety of applications (e.g., medical screening, fraud detections, autonomous driving, etc.). However, large scale collection of sensitive data entails risks in which consequences of mishandling such data could be devastating. Federated learning is a technique that trains a joint model across multiple decentralized edge computing nodes. In federated learning, a centralized server chooses a model and transmits to the model to participating edge nodes. Each node subsequently trains its local copy on its private data and transmits updates to the centralized server, which aggregates the updates to a new global model.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 illustrates one embodiment of a system;

FIG. 2 illustrates one embodiment of a federated learning network;

FIG. 3 illustrates one embodiment of an aggregation mechanism;

FIG. 4 is a flow diagram illustrating one embodiment of a process performed by an aggregator; and

FIG. 5 is a schematic diagram of an illustrative electronic computing device.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

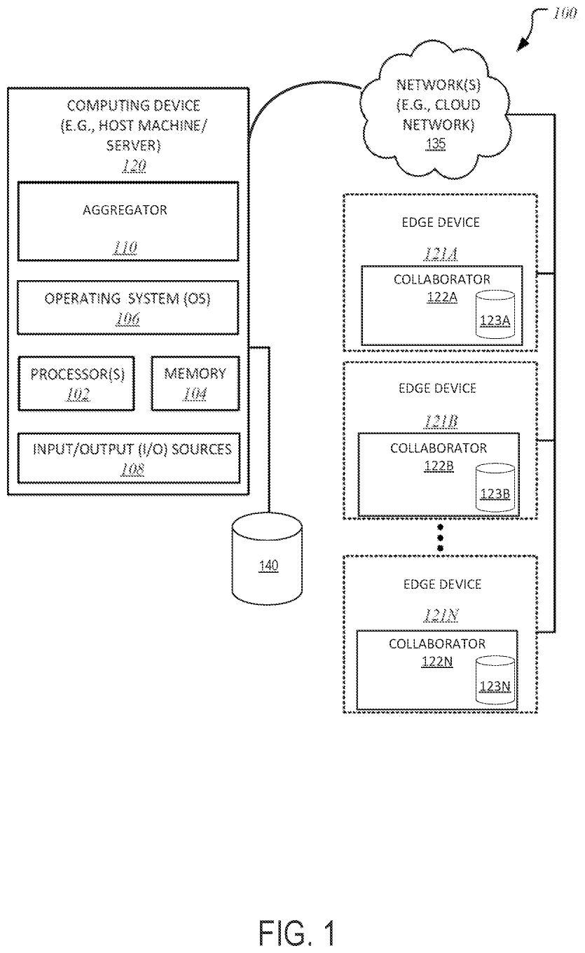

FIG. 1 illustrates one embodiment of a system 100 having a computing device 120 employing an aggregation mechanism (or aggregator) 110 implemented in a federated learning system. As mentioned above, federated learning is a distributed machine learning approach that enables collaboration on machine learning projects without having to share sensitive data, such as, patient records, financial data, or classified information. Thus, the minimum data movement needed across the federation is the model parameters and their updates.

As shown in FIG. 1, computing device 120 includes a host server computer serving as a host machine for employing aggregator 110 to facilitate a machine learning technique to train an algorithm across multiple decentralized edge devices 121A-121N. Computing device 120 may include (without limitation) server computers (e.g., cloud server computers, etc.), desktop computers, cluster-based computers, set-top boxes (e.g., Internet-based cable television set-top boxes, etc.), etc. Computing device 120 includes an operating system (“OS”) 406 serving as an interface between one or more hardware/physical resources of computing device 120 and one or more edge devices 121A-121N, etc. Computing device 120 further includes processor(s) 102, memory 104, input/output (“I/O”) sources 108, such as touchscreens, touch panels, touch pads, virtual or regular keyboards, virtual or regular mice, etc.

Edge devices 121A-N may include (without limitation) organization-based server computers, desktop computers, laptop computers, mobile computing devices, such as smartphones, tablet computers, personal digital assistants, e-readers, media Internet devices, smart televisions, television platforms, wearable devices (e.g., glasses, watches, bracelets, smartcards, jewelry, clothing items, etc.), media players, global positioning system-based navigation systems, cable setup boxes, etc.

In one embodiment, the illustrated database(s) 140 store (without limitation) information and underlying database records having customer and user data therein on to process data on behalf of edge devices 121A-N. In some embodiments, computing device 120 receives input and other requests from a plurality of edge devices 121A-N over one or more networks 135.

In one embodiment, computing device 120 may include a server computer that may be further in communication with one or more databases or storage repositories, such as database(s) 140, which may be located locally or remotely over one or more networks, such as network(s) 135 (e.g., cloud network, Internet, proximity network, intranet, Internet of Things (“IoT”), Cloud of Things (“CoT”), etc.). Computing device 120 is further shown to be in communication with any number and type of other computing devices, such as client computing devices 121A-N, over one or more networks, such as network(s) 135.

In one embodiment, computing device 120 may serve as a host for aggregator 110, and be in communication with one or more edge devices 121A-N, over one or more network(s) 135, and any number and type of dedicated nodes. Edge devices 121A-N each comprise a collaborator client (or collaborator) 122 (e.g., 122A-122N) to operate in coordination with aggregator 110 to federated learning. In such an embodiment, a model is distributed to each of edge devices 121A-121N, where it is stored at a database, trained and transmitted back to aggregator 110.

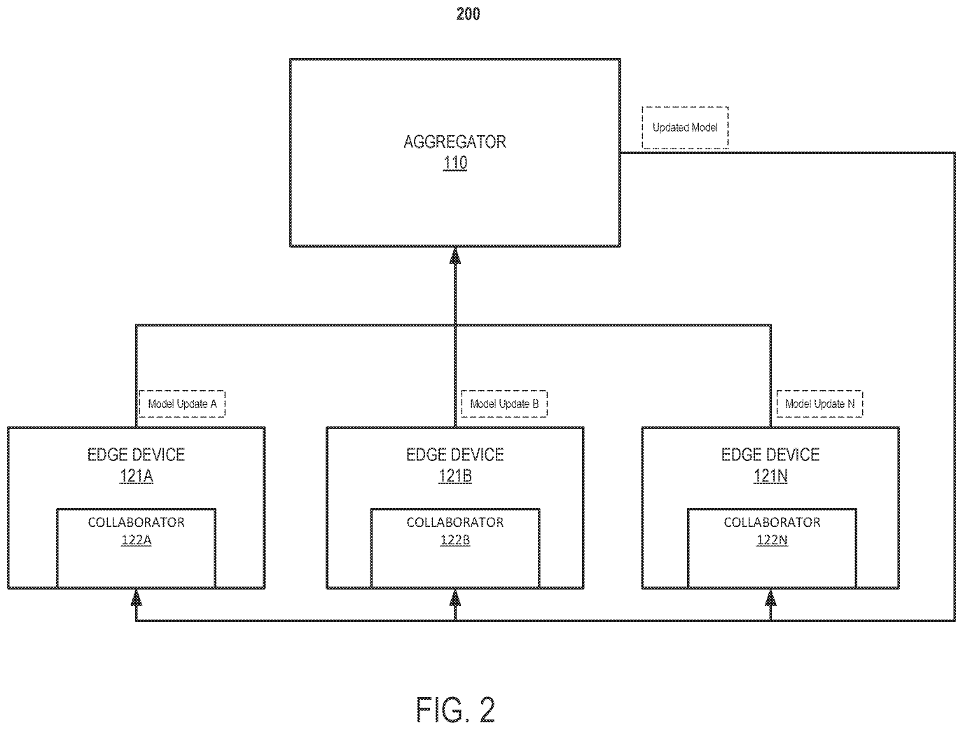

FIG. 2 illustrates one embodiment of a federated learning network 200 including aggregator 110 and edge devices 121A-121N, including collaborators 122A-122N. In one embodiment, a collaborator 122 comprises software that operates on-premises at each edge 121 device participant of the federated learning network 200. In such an embodiment, a collaborator 122 is responsible for executing a training process communicating the updated weights (or gradients) (herein referred to as “trained model update data” or “model updates”) to aggregator 110. As used herein, a weight is a parameter within a neural network that transforms input data within the network, while a gradient is a derivative of a function that has more than one input variable that is implemented to measure a change in all weights with regard to a change in error.

As shown in FIG. 2, model updates (e.g., updates A-N) are transmitted from each collaborator 122 (or data owner) to aggregator 110. Aggregator 110 receives the model updates from all collaborators 122 and integrates the model updates to generate an updated unified model (or unified model) using functions, such as weighted average. Subsequently, the updated model is transmitted to collaborators 122A-122N.

The above-described federated learning network is vulnerable to data poisoning. Specifically, a malicious actor, including a data owner, may feed the training process with specially crafted data that may lead to reduced model quality, a logical backdoor, or increased cost by extending the training process. According to one embodiment, aggregator 110 is configured to detect anomalous model updates that may indicate malicious behavior on the part of a collaborator in a federated learning network. In such an embodiment, aggregator 110 implements an auxiliary machine learning model (or auxiliary model) that learns to predict anomalous model updates. In a further embodiment, aggregator 110 applies the auxiliary model to compare each model update received from a contributor to model updates to a history of updates. Additionally, the auxiliary model compares the model update to model updates received from the other contributors in the same training round of training. In yet a further embodiment, aggregator 110 enables the generation of a set of configurable and learnable rules (or policies) that are adaptable over time for legitimate spikes and acceptable changes.

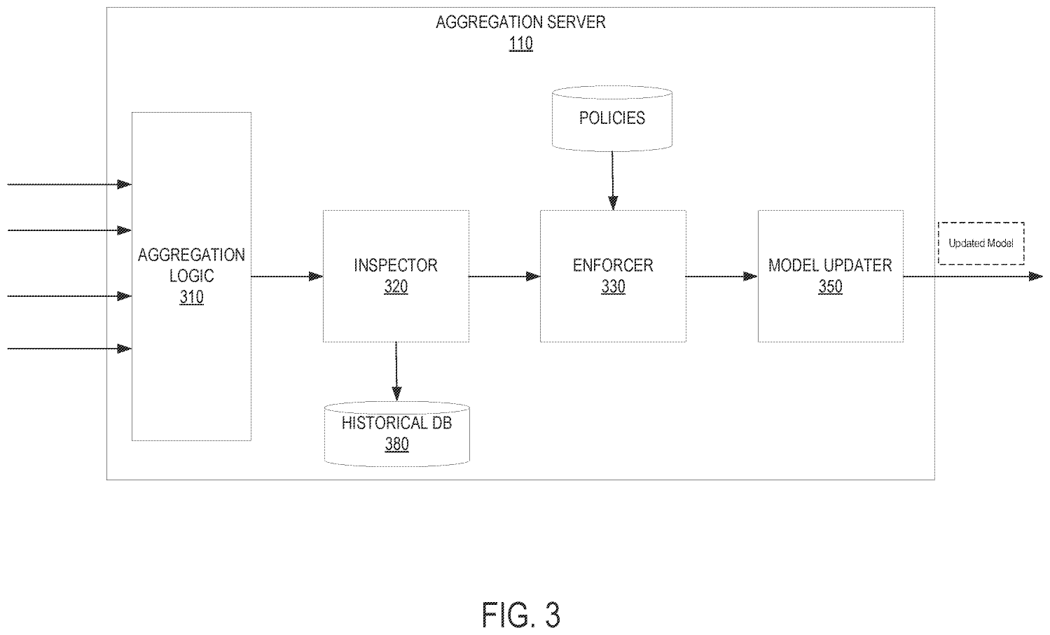

FIG. 3 illustrates one embodiment of aggregator 110. As shown in FIG. 3, aggregator 110 includes aggregation logic 310, inspector 320, enforcer 330 and model updater 350. Aggregation logic 310 receives model updates from the collaborators 122. Inspector 320 comprises an auxiliary machine learning model that is applied to generate a risk score for trained model update data associated with each collaborator 122.

According to one embodiment, the auxiliary model receives the model updates from aggregation logic 310 and compares each model update to historical updates received from a historical database 380 to generate a risk score associated with each model update. For example, the auxiliary model may receive historical updates associated with collaborator 122A from historical database 380 to compare with the received model update associated with collaborator 122A. As used herein, historical updates comprise one or more model updates previously received for a specific collaborator 122. In other embodiments, it is not necessary to maintain all historical model updates. In such an embodiment, learnable parameters are adjusted after each accepted update.

In a further embodiment, the auxiliary model generates the risk score by comparing each model update to the other received model updates to generate the risk score. For example, the auxiliary model may compare the model update associated with collaborator 122A to the model updates associated with collaborators 122B and 122C. Thus, the auxiliary model generates the risk score by comparing received model updates for a collaborator 122 to the historical updates and/or the model updates received for the other collaborators 122.

According to one embodiment, the auxiliary model generates the risk score by performing an anomaly detection algorithm. In such an embodiment, the risk score may comprise a value (e.g., 0 to 100) that indicates the significance of anomaly compared to previously observed anomalies. In a further embodiment, generating the risk score comprises a supervised-learning based score. In this embodiment, a pre-training generation of model updates associated with manually-labeled risk scores is performed. In alternative embodiments, unsupervised risk score learning (e.g., via clustering) may be implemented, or a self-supervised approach using (e.g., contrastive learning) may be deployed.

Enforcer 330 receives the risk score values associated with each model update and applies one or more system policies for a model update to generate an adjusted model update based on the risk score. In one embodiment, each policy is associated with a predetermined risk score range. For example, a policy may indicate that a weight of a model update is adjusted by reducing the model update by a first percentage (e.g., 25%) for risk scores between a first range (e.g., 10-33), a second percentage (e.g., 50%) for risk scores between a second range (e.g., 34-66), a third percentage (e.g., 75%) for risk scores between a first range (e.g., 67-90), and a fourth percentage (e.g., 100%) for risk scores between a fourth range (e.g., >90). A policy may also indicate that an alert is transmitted to a graphical user interface (GUI) for risk scores greater than a predetermined value. In general, a policy may comprise different thresholds for different actors. For example, a specific collaborator may be allowed to transmit updates with higher risk scores based on its trust, known data sources, or other properties.

In a further embodiment, enforcer 330 may enable adjustment of the enforcement policies based on the use case, data sensitivity, etc. As mentioned above with regards to policies, enforcement may be performed based on trust, known data sources or strict data acquisition processes. Model updater 350 generates an updated unified model based on the adjusted model updates associated with each collaborators 122. Subsequently, model updater 350 transmits the unified model to the collaborators 122.

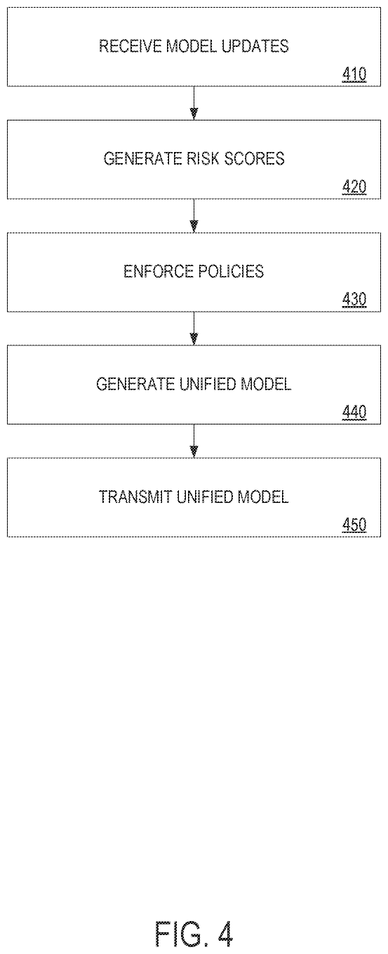

FIG. 4 is a flow diagram illustrating one embodiment of a process performed by an aggregator server. At processing block 410, model updates are received from the collaborators. At processing block 420, the auxiliary model is applied to the model updates to generate a risk score associated with each model update. As discussed above, each risk score is generated using an anomaly detection machine learning algorithm. At processing block 430, a policy is enforced on each model update based on the associated risk score. As discussed above, the policy enforcement on a model update results in the generation of an adjusted model update. At processing block 440, the unified model is generated based on an aggregation of the adjusted model updates. At processing block 450, the unified model is transmitted to the collaborator clients.

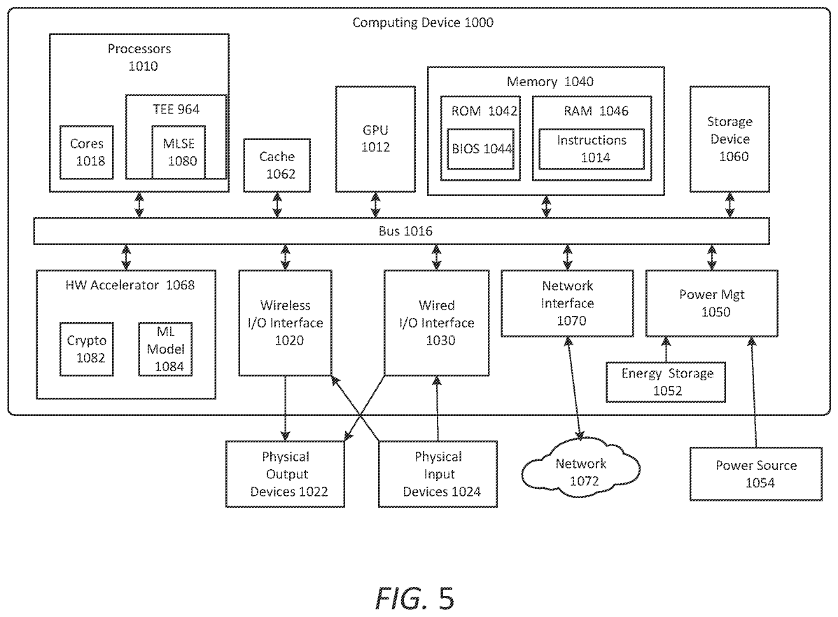

FIG. 5 is a schematic diagram of an illustrative electronic computing device to enable enhanced protection against adversarial attacks according to some embodiments. In some embodiments, the computing device 1000 includes one or more processors 1010 including one or more processors cores 1018 and a Trusted Execution Environment (TEE) 1064, the TEE including a machine learning service enclave (MLSE) 1080. In some embodiments, the computing device 1000 includes a hardware accelerator (HW) 1068, the hardware accelerator including a cryptographic engine 1082 and a machine learning model 1084. In some embodiments, the computing device is to provide enhanced protections against ML adversarial attacks, as provided in FIGS. 1-4.

The computing device 1000 may additionally include one or more of the following: cache 1062, a graphical processing unit (GPU) 1012 (which may be the hardware accelerator in some implementations), a wireless input/output (I/O) interface 1020, a wired I/O interface 1030, memory circuitry 1040, power management circuitry 1050, non-transitory storage device 1060, and a network interface 1070 for connection to a network 1072. The following discussion provides a brief, general description of the components forming the illustrative computing device 1000. Example, non-limiting computing devices 1000 may include a desktop computing device, blade server device, workstation, or similar device or system.

In embodiments, the processor cores 1018 are capable of executing machine-readable instruction sets 1014, reading data and/or instruction sets 1014 from one or more storage devices 1060 and writing data to the one or more storage devices 1060. Those skilled in the relevant art will appreciate that the illustrated embodiments as well as other embodiments may be practiced with other processor-based device configurations, including portable electronic or handheld electronic devices, for instance smartphones, portable computers, wearable computers, consumer electronics, personal computers (“PCs”), network PCs, minicomputers, server blades, mainframe computers, and the like.

The processor cores 1018 may include any number of hardwired or configurable circuits, some or all of which may include programmable and/or configurable combinations of electronic components, semiconductor devices, and/or logic elements that are disposed partially or wholly in a PC, server, or other computing system capable of executing processor-readable instructions.

The computing device 1000 includes a bus or similar communications link 1016 that communicably couples and facilitates the exchange of information and/or data between various system components including the processor cores 1018, the cache 1062, the graphics processor circuitry 1012, one or more wireless I/O interfaces 1020, one or more wired I/O interfaces 1030, one or more storage devices 1060, and/or one or more network interfaces 1070. The computing device 1000 may be referred to in the singular herein, but this is not intended to limit the embodiments to a single computing device 1000, since in certain embodiments, there may be more than one computing device 1000 that incorporates, includes, or contains any number of communicably coupled, collocated, or remote networked circuits or devices.

The processor cores 1018 may include any number, type, or combination of currently available or future developed devices capable of executing machine-readable instruction sets.

The processor cores 1018 may include (or be coupled to) but are not limited to any current or future developed single- or multi-core processor or microprocessor, such as: on or more systems on a chip (SOCs); central processing units (CPUs); digital signal processors (DSPs); graphics processing units (GPUs); application-specific integrated circuits (ASICs), programmable logic units, field programmable gate arrays (FPGAs), and the like. Unless described otherwise, the construction and operation of the various blocks shown in FIG. 5 are of conventional design. Consequently, such blocks need not be described in further detail herein, as they will be understood by those skilled in the relevant art. The bus 1016 that interconnects at least some of the components of the computing device 1000 may employ any currently available or future developed serial or parallel bus structures or architectures.

The system memory 1040 may include read-only memory (“ROM”) 1042 and random access memory (“RAM”) 1046. A portion of the ROM 1042 may be used to store or otherwise retain a basic input/output system (“BIOS”) 1044. The BIOS 1044 provides basic functionality to the computing device 1000, for example by causing the processor cores 1018 to load and/or execute one or more machine-readable instruction sets 1014. In embodiments, at least some of the one or more machine-readable instruction sets 1014 cause at least a portion of the processor cores 1018 to provide, create, produce, transition, and/or function as a dedicated, specific, and particular machine, for example a word processing machine, a digital image acquisition machine, a media playing machine, a gaming system, a communications device, a smartphone, or similar.

The computing device 1000 may include at least one wireless input/output (I/O) interface 1020. The at least one wireless I/O interface 1020 may be communicably coupled to one or more physical output devices 1022 (tactile devices, video displays, audio output devices, hardcopy output devices, etc.). The at least one wireless I/O interface 1020 may communicably couple to one or more physical input devices 1024 (pointing devices, touchscreens, keyboards, tactile devices, etc.). The at least one wireless I/O interface 1020 may include any currently available or future developed wireless I/O interface. Example wireless I/O interfaces include, but are not limited to: BLUETOOTH®, near field communication (NFC), and similar.

The computing device 1000 may include one or more wired input/output (I/O) interfaces 1030. The at least one wired I/O interface 1030 may be communicably coupled to one or more physical output devices 1022 (tactile devices, video displays, audio output devices, hardcopy output devices, etc.). The at least one wired I/O interface 1030 may be communicably coupled to one or more physical input devices 1024 (pointing devices, touchscreens, keyboards, tactile devices, etc.). The wired I/O interface 1030 may include any currently available or future developed I/O interface. Example wired I/O interfaces include, but are not limited to: universal serial bus (USB), IEEE 1394 (“FireWire”), and similar.

The computing device 1000 may include one or more communicably coupled, non-transitory, data storage devices 1060. The data storage devices 1060 may include one or more hard disk drives (HDDs) and/or one or more solid-state storage devices (SSDs). The one or more data storage devices 1060 may include any current or future developed storage appliances, network storage devices, and/or systems. Non-limiting examples of such data storage devices 1060 may include, but are not limited to, any current or future developed non-transitory storage appliances or devices, such as one or more magnetic storage devices, one or more optical storage devices, one or more electro-resistive storage devices, one or more molecular storage devices, one or more quantum storage devices, or various combinations thereof. In some implementations, the one or more data storage devices 1060 may include one or more removable storage devices, such as one or more flash drives, flash memories, flash storage units, or similar appliances or devices capable of communicable coupling to and decoupling from the computing device 1000.

The one or more data storage devices 1060 may include interfaces or controllers (not shown) communicatively coupling the respective storage device or system to the bus 1016. The one or more data storage devices 1060 may store, retain, or otherwise contain machine-readable instruction sets, data structures, program modules, data stores, databases, logical structures, and/or other data useful to the processor cores 1018 and/or graphics processor circuitry 1012 and/or one or more applications executed on or by the processor cores 1018 and/or graphics processor circuitry 1012. In some instances, one or more data storage devices 1060 may be communicably coupled to the processor cores 1018, for example via the bus 1016 or via one or more wired communications interfaces 1030 (e.g., Universal Serial Bus or USB); one or more wireless communications interfaces 1020 (e.g., Bluetooth®, Near Field Communication or NFC); and/or one or more network interfaces 1070 (IEEE 802.3 or Ethernet, IEEE 802.11, or Wi-Fi®, etc.).

Processor-readable instruction sets 1014 and other programs, applications, logic sets, and/or modules may be stored in whole or in part in the system memory 1040. Such instruction sets 1014 may be transferred, in whole or in part, from the one or more data storage devices 1060. The instruction sets 1014 may be loaded, stored, or otherwise retained in system memory 1040, in whole or in part, during execution by the processor cores 1018 and/or graphics processor circuitry 1012.

The computing device 1000 may include power management circuitry 1050 that controls one or more operational aspects of the energy storage device 1052. In embodiments, the energy storage device 1052 may include one or more primary (i.e., non-rechargeable) or secondary (i.e., rechargeable) batteries or similar energy storage devices. In embodiments, the energy storage device 1052 may include one or more supercapacitors or ultracapacitors. In embodiments, the power management circuitry 1050 may alter, adjust, or control the flow of energy from an external power source 1054 to the energy storage device 1052 and/or to the computing device 1000. The power source 1054 may include, but is not limited to, a solar power system, a commercial electric grid, a portable generator, an external energy storage device, or any combination thereof.

For convenience, the processor cores 1018, the graphics processor circuitry 1012, the wireless I/O interface 1020, the wired I/O interface 1030, the storage device 1060, and the network interface 1070 are illustrated as communicatively coupled to each other via the bus 1016, thereby providing connectivity between the above-described components. In alternative embodiments, the above-described components may be communicatively coupled in a different manner than illustrated in FIG. 5. For example, one or more of the above-described components may be directly coupled to other components, or may be coupled to each other, via one or more intermediary components (not shown). In another example, one or more of the above-described components may be integrated into the processor cores 1018 and/or the graphics processor circuitry 1012. In some embodiments, all or a portion of the bus 1016 may be omitted and the components are coupled directly to each other using suitable wired or wireless connections.

The following clauses and/or examples pertain to further embodiments or examples. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to perform acts of the method, or of an apparatus or system for facilitating hybrid communication according to embodiments and examples described herein.

Example 1 includes an apparatus comprising one or more processors to receive trained model update data from each of a plurality of collaborators, execute an auxiliary machine learning model to the trained model update data to generate a risk score for trained model update data associated with each collaborator, apply one or more policies based on the risk scores to generate adjusted trained model update data associated with each collaborator.

Example 2 includes the subject matter of Example 1, wherein the one or more processors further to aggregate the adjusted trained model update data to generate a unified model.

Example 3 includes the subject matter of any of Examples 1 and 2, wherein the auxiliary machine learning model compares trained model update data associated with a first collaborator to historical trained model update data associated with the first collaborator.

Example 4 includes the subject matter of any of Examples 1-3, wherein the auxiliary machine learning model receives the historical trained model update data from a first database.

Example 5 includes the subject matter of any of Examples 1-4, wherein the auxiliary machine learning model compares trained model update data associated with the first collaborator to trained model update data associated with a second collaborator.

Example 6 includes the subject matter of any of Examples 1-5, wherein adjusting the trained model update data comprises adjusting a weight of the trained model update data based on the risk score.

Example 7 includes the subject matter of any of Examples 1-6, wherein a policy is associated with a predetermined risk score range.

Example 8 includes the subject matter of any of Examples 1-7, wherein a first policy indicates that the weight of the trained model update data is adjusted a first percentage upon a determination the risk is within a first predetermined risk score range.

Example 9 includes the subject matter of any of Examples 1-8, wherein a second policy indicates that the weight of the trained model update data is adjusted a second percentage upon a determination the risk is within a second predetermined risk score range.

Example 10 includes the subject matter of any of Examples 1-9, wherein the one or more processors further to transmit the unified model to the plurality of collaborators.

Example 11 includes a method comprising receiving trained model update data from each of a plurality of collaborators, executing an auxiliary machine learning model to the trained model update data to generate a risk score for trained model update data associated with each collaborator and applying one or more policies based on the risk scores to generate adjusted trained model update data associated with each collaborator.

Example 12 includes the subject matter of Example 11, further comprising aggregating the adjusted trained model update data to generate a unified model and transmitting the unified model to the plurality of collaborators.

Example 13 includes the subject matter of any of Examples 11 and 12, wherein executing the auxiliary machine learning model comprises comparing trained model update data associated with a first collaborator to historical trained model update data associated with the first collaborator and comparing trained model update data associated with the first collaborator to trained model update data associated with a second collaborator.

Example 14 includes the subject matter of any of Examples 11-13, wherein adjusting the trained model update data comprises adjusting a weight of the trained model update data based on the risk score.

Example 15 includes the subject matter of any of Examples 11-14, wherein a policy is associated with a predetermined risk score range.

Example 16 includes at least one computer readable medium having instructions stored thereon, which when executed by one or more processors, cause the processors to receive trained model update data from each of a plurality of collaborators, execute an auxiliary machine learning model to the trained model update data to generate a risk score for trained model update data associated with each collaborator, apply one or more policies based on the risk scores to generate adjusted trained model update data associated with each collaborator.

Example 17 includes the subject matter of Example 16, having instructions stored thereon, which when executed by one or more processors, further cause the processors to aggregating the adjusted trained model update data to generate a unified model and transmitting the unified model to the plurality of collaborators.

Example 18 includes the subject matter of any of Examples 16 and 17, wherein executing the auxiliary machine learning model comprises comparing trained model update data associated with a first collaborator to historical trained model update data associated with the first collaborator and comparing trained model update data associated with the first collaborator to trained model update data associated with a second collaborator.

Example 19 includes the subject matter of any of Examples 16-18, wherein adjusting the trained model update data comprises adjusting a weight of the trained model update data based on the risk score.

Example 20 includes the subject matter of any of Examples 16-19, wherein a policy is associated with a predetermined risk score range.

The above Detailed Description includes references to the accompanying drawings, which form a part of the Detailed Description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In addition, “a set of” includes one or more elements. In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim. Moreover, in the following claims, the terms “first,” “second,” “third,” etc. are used merely as labels, and are not intended to suggest a numerical order for their objects.

The terms “logic instructions” as referred to herein relates to expressions which may be understood by one or more machines for performing one or more logical operations. For example, logic instructions may comprise instructions which are interpretable by a processor compiler for executing one or more operations on one or more data objects. However, this is merely an example of machine-readable instructions and examples are not limited in this respect.

The terms “computer readable medium” as referred to herein relates to media capable of maintaining expressions which are perceivable by one or more machines. For example, a computer readable medium may comprise one or more storage devices for storing computer readable instructions or data. Such storage devices may comprise storage media such as, for example, optical, magnetic or semiconductor storage media. However, this is merely an example of a computer readable medium and examples are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and examples are not limited in this respect.

Some of the methods described herein may be embodied as logic instructions on a computer-readable medium. When executed on a processor, the logic instructions cause a processor to be programmed as a special-purpose machine that implements the described methods. The processor, when configured by the logic instructions to execute the methods described herein, constitutes structure for performing the described methods. Alternatively, the methods described herein may be reduced to logic on, e.g., a field programmable gate array (FPGA), an application specific integrated circuit (ASIC) or the like.

In the description and claims, the terms coupled and connected, along with their derivatives, may be used. In particular examples, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Reference in the specification to “one example” or “some examples” means that a particular feature, structure, or characteristic described in connection with the example is included in at least an implementation. The appearances of the phrase “in one example” in various places in the specification may or may not be all referring to the same example.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with each claim standing on its own as a separate embodiment. The scope of the embodiments disclosed herein is to be determined with reference to the appended claims, along with the full scope of equivalents to which such claims are entitled.

Although examples have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. An apparatus comprising:
one or more processors to receive trained model update data from each of a plurality of collaborators, execute an auxiliary machine learning model to the trained model update data to generate a risk score for trained model update data associated with each collaborator and apply one or more policies based on the risk scores to generate adjusted trained model update data associated with each collaborator.

2. The apparatus of claim 1, wherein the one or more processors further to aggregate the adjusted trained model update data to generate a unified model.

3. The apparatus of claim 2, wherein the auxiliary machine learning model compares trained model update data associated with a first collaborator to historical trained model update data associated with the first collaborator.

4. The apparatus of claim 3, wherein the auxiliary machine learning model receives the historical trained model update data from a first database.

5. The apparatus of claim 3, wherein the auxiliary machine learning model compares trained model update data associated with the first collaborator to trained model update data associated with a second collaborator.

6. The apparatus of claim 5, wherein adjusting the trained model update data comprises adjusting a weight of the trained model update data based on the risk score.

7. The apparatus of claim 6, wherein a policy is associated with a predetermined risk score range.

8. The apparatus of claim 7, wherein a first policy indicates that the weight of the trained model update data is adjusted a first percentage upon a determination the risk is within a first predetermined risk score range.

9. The apparatus of claim 8, wherein a second policy indicates that the weight of the trained model update data is adjusted a second percentage upon a determination the risk is within a second predetermined risk score range.

10. The apparatus of claim 3, wherein the one or more processors further to transmit the unified model to the plurality of collaborators.

11. A method comprising:
receiving trained model update data from each of a plurality of collaborators;
executing an auxiliary machine learning model to the trained model update data to generate a risk score for trained model update data associated with each collaborator; and
applying one or more policies based on the risk scores to generate adjusted trained model update data associated with each collaborator.

12. The method of claim 11, further comprising:
aggregating the adjusted trained model update data to generate a unified model; and
transmitting the unified model to the plurality of collaborators.

13. The method of claim 12, wherein executing the auxiliary machine learning model comprises:
comparing trained model update data associated with a first collaborator to historical trained model update data associated with the first collaborator; and
comparing trained model update data associated with the first collaborator to trained model update data associated with a second collaborator.

14. The method of claim 13, wherein adjusting the trained model update data comprises adjusting a weight of the trained model update data based on the risk score.

15. The method of claim 14, wherein a policy is associated with a predetermined risk score range.

16. At least one computer readable medium having instructions stored thereon, which when executed by one or more processors, cause the processors to:
receive trained model update data from each of a plurality of collaborators;
execute an auxiliary machine learning model to the trained model update data to generate a risk score for trained model update data associated with each collaborator; and
apply one or more policies based on the risk scores to generate adjusted trained model update data associated with each collaborator.

17. The computer readable medium of claim 16, having instructions stored thereon, which when executed by one or more processors, further cause the processors to:
aggregate the adjusted trained model update data to generate a unified model; and
transmitting the unified model to the plurality of collaborators.

18. The computer readable medium of claim 17, wherein executing the auxiliary machine learning model comprises:
comparing trained model update data associated with a first collaborator to historical trained model update data associated with the first collaborator; and
comparing trained model update data associated with the first collaborator to trained model update data associated with a second collaborator.

19. The computer readable medium of claim 18, wherein adjusting the trained model update data comprises adjusting a weight of the trained model update data based on the risk score.

20. The computer readable medium of claim 19, wherein a policy is associated with a predetermined risk score range.
